(19) United States
(12) Patent Application Publication
(10) Pub. No.: US 2007/0136153 A1
(43) Pub. Date: Jun. 14, 2007

(54) Apparatus for managing inventory in Internet based multistage logistics collaborative system and method thereof

(76) Inventors: Woo-Kwan Chun, Daejon (KR); Hoon Jung, Daejon (KR); Keum-Woo Lee, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/634,424

(22) Filed: Dec. 6, 2006

(30) Foreign Application Priority Data
Dec. 9, 2005 (KR) 10-2005-0121113
Aug. 30, 2006 (KR) 10-2006-0083173

(51) Int. Cl. G06Q 10/00

(52) U.S. Cl. 705/28; 705/26

(57) ABSTRACT

An apparatus and method for managing inventory in an Internet based multistage logistics collaborative system are provided. The apparatus includes: an inventory management apparatus for managing sale and inventory information in real time, determining whether an automatic product supply to perform or not based on inventory in each distributor, and calculating a proper supply quantity according to the determination result; a supply order generator for transmitting the calculated proper supply quantity to each distributor, creating a supply order after a corresponding distributor confirms and modifies a reservation of receiving a corresponding product, and storing the created supply order; and a sale order generator for generating a sale order of a corresponding distributor when the product is automatically supplied to the corresponding distributor from a manufacturer based on the created supply order, and storing the generated sale order in the sale information storing unit.

### FIELD OF THE INVENTION

The present invention relates to an apparatus for managing inventory in an Internet based multistage logistics collaborative system, and a method thereof; and, more particularly, to an inventory management apparatus in an Internet based multistage logistics collaborative system, for automatically supplying products to corresponding distributors by sharing accurate sale and inventory information of each product with companies contracted as a logistics collaborated partner, which are companies approved to use a partner managed inventory (PMI) function, in real time, and estimating demands based on sale and inventory information of distributors contracted as a logistics collaborative partner, and a method thereof.

### DESCRIPTION OF RELATED ARTS

Conventional Internet based multistage logistics collaborative systems simply manage sale and inventory information of a company, and inventory information and marketing information, and process orders for purchasing or selling products without sharing information with other sellers and suppliers. The conventional logistics collaborative systems have a problem of not supporting automatic supply strategies such as a vendor management inventory (VMI) system, a collaboration management infrastructure (CMI), and a just in time (JIT) system, which uses an advantageous characteristic of the Internet, real-time processing.

Conventional server/client-based supply chain management (SCM) systems have a problem of not providing a real time service although it has been successfully applied as an inventory management solution among partners.

### SUMMARY OF THE INVENTION

It is, therefore, an object of the present invention to provide an inventory management apparatus in an Internet based multistage logistics collaborative system, for automatically supplying products to corresponding distributors by sharing accurate sale and inventory information of each product with companies contracted as a logistics collaborated partner, which are companies approved to use a partner managed inventory (PMI) function, in real time, and estimating demands based on sale and inventory information of distributors contracted as a logistics collaborative partner, and a method thereof.

In accordance with an aspect of the present invention, there is also provided an apparatus for managing inventory in an Internet based multistage logistics collaborative system, including: an inventory managing unit for modifying and managing a present inventory condition of an inventory information storing unit in real time by analyzing a quantity of stacking and delivering each product, determining whether an automatic product supply to perform or not for supplying predetermined products to a corresponding distributor by analyzing a present inventory condition of each distributor through a partner managed inventory (PMI) approval of a web server, and calculating a proper supply quantity of a corresponding product according to the determination result; a supply order generating unit for transmitting the calculated proper supply quantity to each distributor, creating a supply order after a corresponding distributor confirms and modifies a reservation of receiving a corresponding product, and storing the created supply order in a sale information storing unit; and a sale order generating unit for generating a sale order of a corresponding distributor when the corresponding product is automatically supplied to the corresponding distributor from a manufacturer based on the created supply order, and storing the generated sale order in the sale information storing unit.

In accordance with another aspect of the present invention, there is provided a method for managing inventory in an Internet based multistage logistics collaborative system, including the steps of: a) storing present sale and inventory information of each product in an inventory information storing unit and a sale information storing unit in real time by analyzing a present condition of ordering, delivering, receiving and stocking products from a manufacturer terminal and a distributor terminal, which are contracted each other as an Internet logistics collaborative partner; b) determining whether or not a manufacturer terminal accessed through the Internet is a manufacturer terminal approved to use a partner managed inventory (PMI) function; c) transferring present sale and inventory information of products, which are supplied to a distributor, to the accessed manufacturer terminal according to the determining result of the step b); d) determining whether or not an automatic product supply to perform for automatically supplying predetermined products to the corresponding distributor from the accessed manufacturer based on the present sale and inventory information stored in the inventory information storing unit and the sale information storing unit; e) calculating a proper supply quantity based on the present sale and inventory information of corresponding products of a distributor stored in the inventory information storing unit and the purchase information storing unit; f) transferring the calculated proper supply quantity to a corresponding distributor, and creating a supply order after confirming a reservation of receiving a corresponding product and modified information from a corresponding distributor, and storing the created supply order in the sale information storing unit; and g) creating a sale order of a corresponding distributor when a corresponding product is supplied from a corresponding manufacturer to a corresponding distributor, and storing the sale order in the sale information storing unit.

According to the certain embodiment of the present invention, the inventory of each product can be sustained within a proper level by directly managing the inventory of collaborative manufacturers using an Internet based supply chain management (eSCM) solution. Also, related products can be automatically and constantly supplied to distributors by receiving information about the present inventory condition and sales of collaborative distributors, estimating future demands of related products based on the received information, and calculating a proper amount of products to supply in consideration of maximum and minimum level of inventory in the distributors.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram illustrating an Internet based multistage logistics collaborative system;

FIG. 2 is a block diagram illustrating an inventory management apparatus in an Internet based multistage logistics collaborative system in accordance with an embodiment of the present invention; and

FIG. 3 is a flowchart illustrating a method for managing inventory in an Internet based multistage logistics collaborate system in accordance with an embodiment of the present invention.

### DETAILED DESCRIPTION OF THE INVENTION

Hereinafter, an inventory management apparatus in an Internet based multistage logistics collaborative system will be described in more detail with reference to the accompanying drawings.

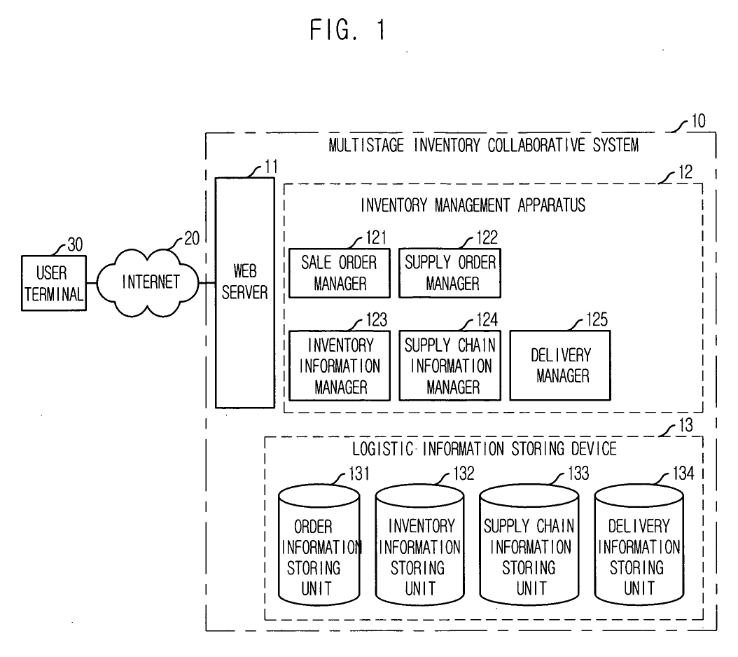

FIG. 1 is a block diagram illustrating an Internet based multistage logistics collaborative system.

Referring to FIG. 1, the Internet based multistage logistics collaborative system 10 includes a web server 11, an inventory management apparatus 12, and an inventory information storing device 13. The web server 11 supports communication between the multistage logistics collaborative system and a user terminal 30 through the Internet 20. The inventory management apparatus 12 manages inventories for cooperation between a manufacturer and a distributor, which approve a partner managed inventory (PMI) function. The inventory information storing unit stores the information about inventories.

The inventory management apparatus 12 includes a sale order manager 121 for managing sale orders of products, a supply order manager 122 for managing the supply of ordered products, an inventory information manager 123 for managing inventory information of products, a supply chain information manager 124 for managing basic information of supply chains of products, and a delivery manager 125 for managing product delivery.

The inventory information storing device 13 includes an order information storing unit 131 for storing order information of products, an inventory information storing unit 132 for storing inventory information, a supply chain information storing unit 133 for storing basic information about the supply chain of a product, and a delivery information storing unit 134 for storing delivery information of products.

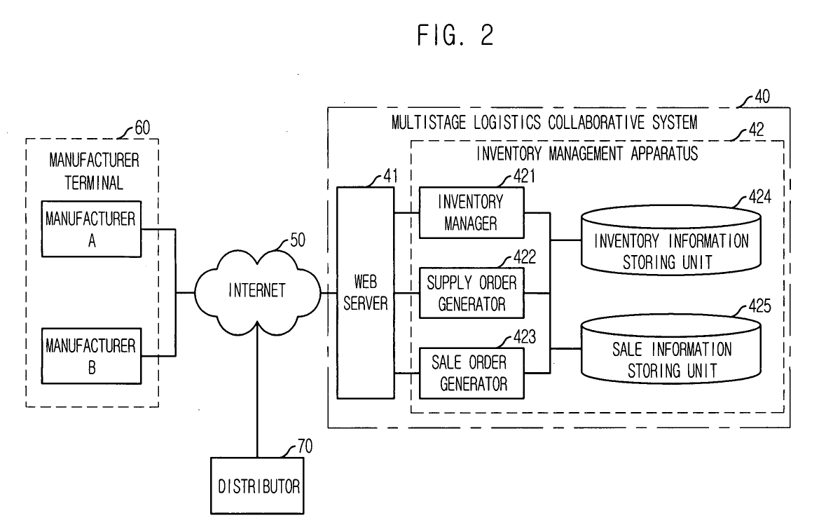

FIG. 2 is a block diagram illustrating an inventory management apparatus in an Internet based multistage logistics collaborative system in accordance with an embodiment of the present invention.

Referring to FIG. 2, the Internet based multistage logistics collaborative system 40 according to the present embodiment includes a web server 41 and an inventory management apparatus 42. The web server 41 supports communication between a manufacturer terminal 60 and a distributor terminal 70. Herein, the manufacturer terminal 60 is a user terminal of a manufacturer contracted as a logistics collaborative partner, which is a manufacturer approved to use a partner managed inventory (PMI) function through the Internet 50, and the distributor terminal 70 is a user terminal of a distributor contracted as a logistics collaborative partner, which is a distributor approved to use a partner managed inventory (PMI) function through the Internet 50. The inventory management apparatus 42 manages information about stocking products, delivering products, and inventories, and decides automatic inventory supply to perform in order to supply related products to the distributors.

The inventory management apparatus 42 includes an inventory manager 421, a supply order generator 422, a sale order generator 423, an inventory information storing unit 424, and a sale information storing unit 425. The inventory manager 421 learns the quantity of stocked or delivered products, updates inventory information stored in an inventory information storing unit 424 in real time, and manages the inventor information. The inventory manager 421 also analyzes a present inventory condition of each distributor through the PMI approval of the web server 41, decides the automatic inventory supply to perform for automatically supplying related products to the distributor according to the analyzed inventory condition, and calculates a proper supply quantity to each distributor. The supply order generator 422 transmits the calculated supply quantity from the inventory manager 421 to each distributor. After the distributor confirms and modifies the reservation of stocking corresponding products, the supply order generator 422 creates a supply order and stores the generated supply order in the sale information storing unit 124. The sale order generator 423 creates a sale order of each distributor when a manufacturer automatically delivers products to a distributor based on the generated supply order from the supply order generator 422, and stores the created sale order in the sale information storing unit 425. The inventory information storing unit 424 stores inventory information of each product. The sale information storing unit 425 stores supply and sale order information of each product.

The inventory manager 421 determines automatic inventory supply to perform for automatically supplying related products to the distributors based on a proper inventory quantity, which is set-up when the distributor terminal 70 is initially registered to the Internet based multistage logistics collaborative system 40. That is, the inventory manager 421 determines whether the automatic inventory supply is performed or not based on the initial proper level of inventory quantity, set-up by a distributor per each product when a manufacturer approves PMI for a product supplied from a manufacturer to a distributor. Herein, the inventory manager 421 calculates a proper supply quantity based on the same and inventory information of a corresponding product of a distributor stored in the inventory information storing unit 424 and the sale information storing unit 425 if the quantity of products stocked in the distributor is dropped under the initial proper level of inventory quantity. The inventory manager 421 calculates the proper supply quantity of a corresponding product using a method of calculating an economic order quantity (EOQ) as like Eq. 1.

$$E = {( \frac{\begin{matrix}2 \times quantity of one year demand \times \\ cost of one time order\end{matrix}}{cost of sustaining unit inventory} )}^{0.5} \qquad Eq . 1$$

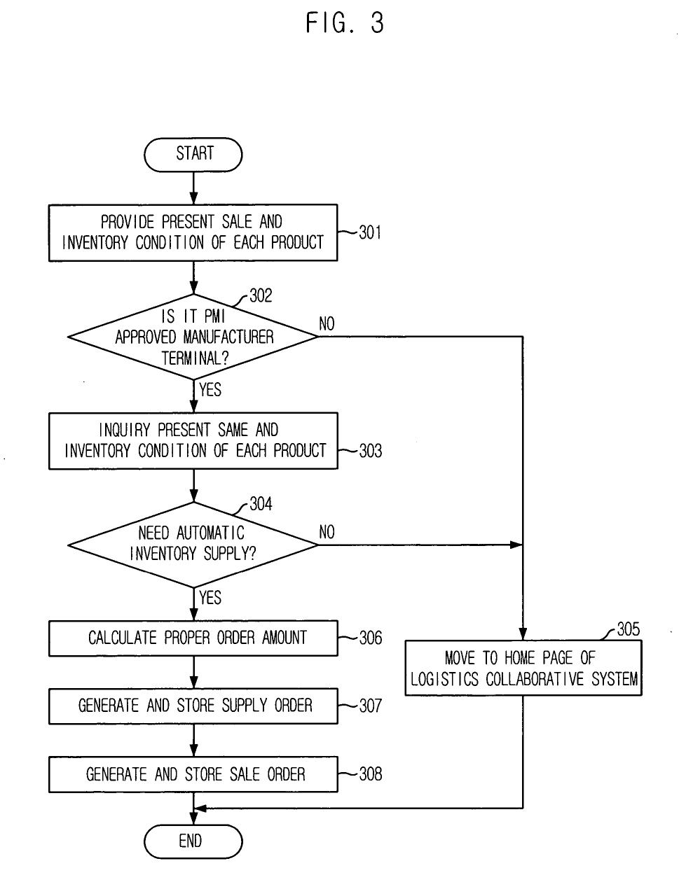

FIG. 3 is a flowchart illustrating a method for managing inventory in an Internet based multistage logistics collaborate system in accordance with an embodiment of the present invention.

Referring to FIG. 3, at step S301, the inventory manager 421, the supply order generator 422 and the sale order generator 423 of the multistage logistics collaborate system 40 learn the present conditions of ordering, delivering, receiving and stocking products from the manufacturer terminal 60 and the distributor terminal 70, which are contracted to each other as a logistics collaborative partner through the Internet 50, and stores sale and inventory information in the inventory information storing unit 424 and the sale information storing unit 425.

At step S302, the web server 41 determines whether a manufacturer terminal accessed through the Internet 50 is approved to use a PMI function or not. That is, the web server 41 determines whether the accessed terminal is the manufacturer terminal 60 contracted as a logistics collaborative partner or not at step S302. If the accessed terminal is not the manufacturer terminal 60, the web server 41 outputs a home page of the logistics collaborative system to the accessed manufacturer terminal at step S305.

The home page of the logistics collaborative system is the first page opened when a user access the web server 11. In general, the first page thereof is for registering a sale order.

If the accessed terminal is the manufacturer terminal 60 at step S302, the present sale and inventory information is transferred to the manufacturer terminal 60 at step S303.

The inventory manager 421 determines whether the automatic product supply to perform or not for supplying related products to a corresponding distributor from a manufacturer based on the sale and inventory information stored in the inventory information storing unit 424 and the sale information storing unit 425 at step S304. Then, if the inventory manager 421 determines the automatic product supply not to perform, the home page of the logistics collaborative system is outputted to the manufacturer terminal 60 at step S305.

That is, the web server 14 outputs the home page of the logistics collaborative system if the automatic product supply is not required when the manufacturer terminal 60 accesses the web server 14.

If the inventory manager 421 determines the automatic product supply to perform at step S304, the inventory manager 421 calculates a proper supply quantity based on the present sale and inventory information of corresponding products of a distributor, which are stored in the inventory information storing unit 424 and the purchase information storing unit 425, at step S306.

Then, the supply order generator 422 transmits the calculated proper supply quantity of the corresponding product to each distributor terminal 70, creates a supply order based on information about confirming a reservation of receiving a corresponding product and updated information from the distributor terminal 70, and stores the created supply order in the sale information storing unit 425 at step S307. At step S308, the sale order generator 423 creates a sale order of each distributor if the corresponding products are automatically delivered from a manufacturer to a distributor, and stores the created sale order in the sale information storing unit 425.

As described above, the manufacturer can supply products to the distributors using a delivery company or an own delivery system through the logistics collaborative procedure.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean patent application No. KR 2005-121113 and KR 2006-83173 filed in the Korean patent office on Dec. 9, 2005, and Aug. 30, 2006, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. An apparatus for managing inventory in an Internet based multistage logistics collaborative system, comprising:
an inventory managing means for modifying and managing a present inventory condition of an inventory information storing means in real time by analyzing a quantity of stacking and delivering each product, determining whether an automatic product supply to perform or not for supplying predetermined products to a corresponding distributor by analyzing a present inventory condition of each distributor through a partner managed inventory (PMI) approval of a web server, and calculating a proper supply quantity of a corresponding product according to the determination result;
a supply order generating means for transmitting the calculated proper supply quantity to each distributor, creating a supply order after a corresponding distributor confirms and modifies a reservation of receiving a corresponding product, and storing the created supply order in a sale information storing means; and
a sale order generating means for generating a sale order of a corresponding distributor when the corresponding product is automatically supplied to the corresponding distributor from a manufacturer based on the created supply order, and storing the generated sale order in the sale information storing means.

2. The apparatus as recited in claim 1, wherein the inventory managing means determines whether or not the automatic product supply to perform for automatically supplying predetermined products to a corresponding distributor based on a proper inventory quantity which is set up when a user terminal of each distributor is initially registered at the multistage logistics collaborative system.

3. A method for managing inventory in an Internet based multistage logistics collaborative system, comprising the steps of:
a) storing present sale and inventory information of each product in an inventory information storing means and a sale information storing means in real time by analyzing a present condition of ordering, delivering, receiving and stocking products from a manufacturer terminal and a distributor terminal, which are contracted each other as an Internet logistics collaborative partner;
b) determining whether or not a manufacturer terminal accessed through the Internet is a manufacturer terminal approved to use a partner managed inventory (PMI) function;
c) transferring present sale and inventory information of products, which are supplied to a distributor, to the accessed manufacturer terminal according to the determining result of the step b);
d) determining whether or not an automatic product supply to perform for automatically supplying predetermined products to the corresponding distributor from the accessed manufacturer based on the present sale and inventory information stored in the inventory information storing means and the sale information storing means;
e) calculating a proper supply quantity based on the present sale and inventory information of corresponding products of a distributor stored in the inventory information storing means and the purchase information storing means;
f) transferring the calculated proper supply quantity to a corresponding distributor, and creating a supply order after confirming a reservation of receiving a corresponding product and modified information from a corresponding distributor, and storing the created supply order in the sale information storing means; and
g) creating a sale order of a corresponding distributor when a corresponding product is supplied from a corresponding manufacturer to a corresponding distributor, and storing the sale order in the sale information storing means.

4. The method as recited in claim 3, further comprising the step of outputting a home page of a logistics collaborative system to the access manufacturer terminal if the access terminal is not the manufacturer terminal approved to use a partner managed inventory (PMI) function in the step b).

5. The method as recited in claim 3, further comprising the step of outputting a home page of a logistics collaborative system to the access manufacturer terminal if the automatic product supply is not required to perform in the step d).

6. The method as recited in claim 4, wherein the home page of the logistics collaborative system is a first page shown when a web service is initially accessed.
